(19) United States
(12) Patent Application Publication
(10) Pub. No.: US 2016/0225096 A1
(43) Pub. Date: Aug. 4, 2016

(54) HEALTH INSURANCE PLAN MATCHING

(71) Applicant: User Health Systems, LLC, Chicago, IL (US)

(72) Inventors: Christian WELLS, Oak Park, IL (US); Ronald Lump, Chicago, IL (US)

(73) Assignee: User Health Systems, LLC

(21) Appl. No.: 14/612,087

(22) Filed: Feb. 2, 2015

(51) Int. Cl. G06Q 40/08

(52) U.S. Cl. CPC G06Q 40/08; G06Q 50/22

(57) ABSTRACT

An apparatus for generating a listing of available health insurance plans and associated costs includes a user interface module for generating and transmitting to a client a graphical user interface (GUI) that requests information concerning an existing health condition of a patient. The apparatus also includes a recommendation engine communicatively coupled with the user interface module, wherein the recommendation engine is adapted to receive the information concerning the existing health condition of the patient from the user interface module. The apparatus also includes one or more databases, which store information concerning a plurality of health insurance plans. The recommendation engine is further adapted to analyze the information concerning the health insurance plans in view of the patient's existing health condition and generate the listing of available health insurance plans and associated costs.

### BACKGROUND

Since the Affordable Healthcare Act went into effect, numerous organizations known as health insurance marketplaces or health exchanges have been set up to facilitate the purchase of health insurance. Those marketplaces often have websites that provide information on the various health insurance plans available through the marketplaces. Some of those websites allow a user to input information concerning the user and his or her family (if applicable), such as ages and location, and then provide the user with estimated applicable premiums, deductibles, out-of-pocket maximums and coverage for the available plans.

Comparing one health insurance plan to another can be extremely complicated and confusing for the average health insurance consumer, because health insurance plans vary greatly in terms of the interplay of deductibles, copays and coinsurance. Consequently, many health insurance consumers wrongly assume that the health insurance plan with the lowest premium will cost them the least amount of money.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

An embodiment of the present invention is directed to an apparatus for generating a listing of available health insurance plans and associated costs for a client that is communicatively coupled with the apparatus via a network. The apparatus includes a user interface module for generating and transmitting a graphical user interface (GUI) to a client. The user interface module requests and receives via the GUI information concerning an existing health condition of a patient. The apparatus also includes a recommendation engine communicatively coupled with the user interface module. The recommendation engine is adapted to receive the information concerning the existing health condition of the patient from the user interface module. The apparatus also includes one or more databases communicatively coupled with the recommendation engine. The one or more databases store information concerning a plurality of health insurance plans. The information includes at least an identifier for each plan and a description of benefits for each plan. The recommendation engine is further adapted to analyze the information concerning the health insurance plans in view of the received information concerning the existing health condition of the patient and generate and provide to the user interface module the listing of available health insurance plans and associated costs. The associated costs for a given health insurance plan in the listing include at least a health insurance premium component and a healthcare cost component, where the healthcare cost component is based on the information concerning the existing health condition of the patient. The user interface module is adapted to transmit the listing of available health insurance plans and associated costs to the client to be displayed via the GUI.

Another embodiment of the present invention is directed to a method for generating a listing of available health insurance plans and associated costs. The method includes storing in one or more databases information concerning a plurality of health insurance plans. The information includes at least an identifier for each plan and a description of benefits for each plan. The method also includes generating a graphical user interface (GUI), transmitting the GUI to a client, requesting via the GUI information concerning an existing health condition of a patient, receiving the information concerning the existing health condition from the client via the GUI, determining healthcare costs for the patient under the health insurance plans based on the information concerning the existing health condition of the patient, and generating the listing of available health insurance plans and associated costs. The associated costs for a given health insurance plan in the listing includes at least a health insurance premium component and the corresponding healthcare cost for the patient under the given health insurance plan. The method further includes transmitting the listing of available health insurance plans and associated costs to the client to be displayed via the GUI.

Another embodiment of the present invention is directed to a system for generating a listing of available health insurance plans and associated costs for a client that is communicatively coupled with the apparatus via a network, the system includes a network, a client communicatively coupled with the network, and a server communicatively coupled with the client via the network. The server includes a user interface module for generating and transmitting a graphical user interface (GUI) to a client. The user interface module requests and receives via the GUI information concerning an existing health condition of a patient. The server further includes a recommendation engine communicatively coupled with the user interface module. The recommendation engine is adapted to receive the information concerning the existing health condition of the patient from the user interface module. The server further includes one or more databases communicatively coupled with the recommendation engine. The one or more databases store information concerning a plurality of health insurance plans, including at least an identifier for each plan and a description of benefits for each plan. The recommendation engine is further adapted to analyze the information concerning the health insurance plans in view of the received information concerning the existing health condition of the patient and generate and provide to the user interface module the listing of available health insurance plans and associate costs. The associated costs for a given health insurance plan in the listing include at least a health insurance premium component and a healthcare cost component. The healthcare cost component is based on the information concerning the existing health condition of the patient. The user interface module is adapted to transmit the listing of available health insurance plans and associated costs to the client to be displayed via the GUI.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a block diagram of an exemplary system for implementing embodiments, in accordance with various embodiments of the present invention;

FIG. 2 is a block diagram of a health insurance plan matching system, in accordance with an embodiment of the present invention;

FIG. 3 illustrates an example plan table, in accordance with various embodiments of the present invention;

FIG. 4 illustrates an example master drug table, in accordance with various embodiments of the present invention;

FIG. 5 illustrates an example drug formulary table, in accordance with various embodiments of the present invention;

FIG. 6 illustrates an example conditions table, in accordance with various embodiments of the present invention;

FIG. 7 illustrates a first display of a graphical user interface, in accordance with various embodiments of the present invention;

FIG. 8 illustrates a second display of a graphical user interface, in accordance with various embodiments of the present invention;

FIG. 9 illustrates a third display of a graphical user interface, in accordance with various embodiments of the present invention;

FIG. 10 illustrates a fourth display of a graphical user interface, in accordance with various embodiments of the present invention;

FIG. 11 illustrates a fifth display of a graphical user interface, in accordance with various embodiments of the present invention;

FIG. 12 illustrates a sixth display of a graphical user interface, in accordance with various embodiments of the present invention;

FIG. 13 illustrates a seventh display of a graphical user interface, in accordance with various embodiments of the present invention;

FIG. 14 illustrates a eighth display of a graphical user interface, in accordance with various embodiments of the present invention;

FIG. 15 illustrates a ninth display of a graphical user interface, in accordance with various embodiments of the present invention;

FIG. 16 illustrates a tenth display of a graphical user interface, in accordance with various embodiments of the present invention;

FIG. 17 illustrates a eleventh display of a graphical user interface, in accordance with various embodiments of the present invention;

FIG. 18A illustrates a first portion of a flowchart of a process for health insurance plan matching, in accordance with various embodiments of the present invention;

FIG. 18B illustrates a second portion of a flowchart of a process for health insurance plan matching, in accordance with various embodiments of the present invention; and

FIG. 18C illustrates a third portion of a flowchart of a process for health insurance plan matching, in accordance with various embodiments of the present invention;

FIG. 19 illustrates a flowchart of a process for determining healthcare costs, in accordance with various embodiments of the present invention.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the claims. Furthermore, in the detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

Some portions of the detailed descriptions that follow are presented in terms of procedures, logic blocks, processing, and other symbolic representations of operations on data bits within a computer or digital system memory. These descriptions and representations are the means used by those skilled in the data processing arts to most effectively convey the substance of their work to others skilled in the art. A procedure, logic block, process, etc., is herein, and generally, conceived to be a self-consistent sequence of steps or instructions leading to a desired result. The steps are those requiring physical manipulations of physical quantities. Usually, though not necessarily, these physical manipulations take the form of electrical or magnetic signals capable of being stored, transferred, combined, compared, and otherwise manipulated in a computer system or similar electronic computing device. For reasons of convenience, and with reference to common usage, these signals are referred to as bits, values, elements, symbols, characters, terms, numbers, or the like with reference to the present invention.

It should be borne in mind, however, that all of these terms are to be interpreted as referencing physical manipulations and quantities and are merely convenient labels and are to be interpreted further in view of terms commonly used in the art. Unless specifically stated otherwise as apparent from the discussion herein, it is understood that throughout discussions of the present embodiment, discussions utilizing terms such as “determining” or “outputting” or “transmitting” or “recording” or “locating” or “storing” or “displaying” or “receiving” or “recognizing” or “utilizing” or “generating” or “providing” or “accessing” or “checking” or “notifying” or “delivering” or the like, refer to the action and processes of a computer system, or similar electronic computing device, that manipulates and transforms data. The data is represented as physical (electronic) quantities within the computer system's registers and memories and is transformed into other data similarly represented as physical quantities within the computer system memories or registers or other such information storage, transmission, or display devices.

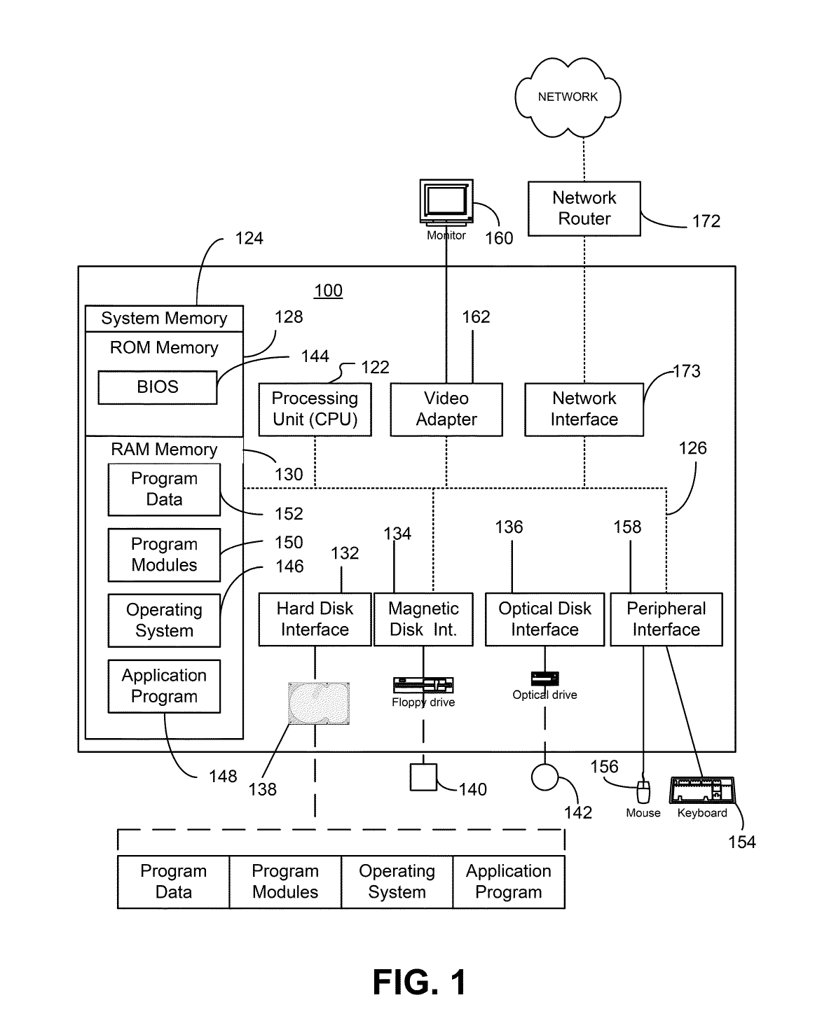

With reference to FIG. 1, an exemplary system for implementing embodiments includes a general purpose computing system environment 100, such as a desktop computer, laptop, smartphone, tablet, or any other such device having the ability to execute instructions, such as those stored within a non-transient, computer-readable medium. Furthermore, while described and illustrated in the context of a single computing system 100, those skilled in the art will also appreciate that the various tasks described hereinafter may be practiced in a distributed environment having multiple computing systems 100 linked via a local or wide-area network in which the executable instructions may be associated with and/or executed by one or more of multiple computing systems 100.

In its most basic configuration, computing system environment 100 typically includes at least one processing unit 122 and at least one memory 124, which may be linked via a bus 126. Depending on the exact configuration and type of computing system environment, memory 124 may be volatile (such as RAM 130), non-volatile (such as ROM 128, flash memory, etc.) or some combination of the two. Computing system environment 100 may have additional features and/or functionality. For example, computing system environment 100 may also include additional storage (removable and/or non-removable) including, but not limited to, magnetic or optical disks, tape drives and/or flash drives. Such additional memory devices may be made accessible to the computing system environment 100 by means of, for example, a hard disk drive interface 132, a magnetic disk drive interface 134, an optical disk drive interface 136, and/or an interface for other forms of removable storage, such as flash memory. As will be understood, these devices, which would be linked to the system bus 126, respectively, allow for reading from and writing to a hard disk 138, reading from or writing to a removable magnetic disk 140, and/or for reading from or writing to a removable optical disk 142, such as a CD/DVD ROM or other optical media. The drive interfaces and their associated computer-readable media allow for the nonvolatile storage of computer readable instructions, data structures, program modules and other data for the computing system environment 100. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, other read/write and/or read-only memories and/or any other method or technology for storage of information such as computer readable instructions, data structures, program modules or other data. Any such computer storage media may be part of computing system environment 100.

A number of program modules may be stored in one or more of the memory/media devices. For example, a basic input/output system (BIOS) 144, containing the basic routines that help to transfer information between elements within the computing system environment 100, such as during start-up, may be stored in ROM 128. Similarly, RAM 130, hard drive 138, and/or peripheral memory devices may be used to store computer executable instructions comprising an operating system 146, one or more applications programs 148, other program modules 150, and/or program data 152. Still further, computer-executable instructions may be downloaded to one or more of the computing devices as needed, for example, via a network connection.

An end-user may enter commands and information into the computing system environment 100 through input devices such as a keyboard 154 and/or a pointing device 156. While not illustrated, other input devices may include a touchscreen interface, a microphone, a joystick, a game pad, a scanner, etc. These and other input devices would typically be connected to the processing unit 122 by means of a peripheral interface 158 which, in turn, would be coupled to bus 126. Input devices may be directly or indirectly connected to processor 122 via interfaces such as, for example, a parallel port, game port, firewire, or a universal serial bus (USB). To view information from the computing system environment 100, a monitor 160 or other type of display device may also be connected to bus 126 via an interface, such as via video adapter 162. In addition to the monitor 160, the computing system environment 100 may also include other peripheral output devices, not shown, such as speakers and printers.

The computing system environment 100 may also utilize logical connections to one or more remote computing system environments. In this regard, it will be appreciated that the remote computing system environment may, like computing system environment 100, be any type of device having processing capabilities. Again, it will be appreciated that the remote computing system environment need not be implemented as a single device but may be implemented in a manner such that the tasks performed by the remote computing system environment are distributed to a plurality of computing system environments linked through a communication network.

For performing tasks as needed, the remote computing system environment may include many or all of the elements described above relative to the computing system environment 100. Communications between the computing system environment 100 and the remote computing system environment may be exchanged via a further processing device, such a network router 172, that is responsible for network routing. Communications with the network router 172 may be performed via a network interface component 173. Thus, within such a networked environment, e.g., the Internet, World Wide Web, LAN, or other like type of wired or wireless network, it will be appreciated that program modules depicted relative to the computing system environment 100, or portions thereof, may be stored in the memory storage device(s) of the remote computing system environment.

Generally speaking, embodiments provide methods, systems and apparatuses for assisting potential insureds in finding health insurance plans that best match their needs. Various embodiments consider additional factors beyond just the base premium applicable to a potential insured to provide the potential insured with “true costs” of available health insurance plans. For example, various embodiments estimate a healthcare cost (i.e., a potential insured's estimated out-of-pocket cost) that considers a health condition of the potential insured, expected prescription drugs, expected doctor visits and the benefits of the various insurance plans (e.g. deductibles, copays, out-of-pocket maximums). As a result, potential insureds are provided with estimated true costs of health insurance plans based on both base premiums as well as expected healthcare consumption, thereby enabling potential insureds to make more informed decisions as to which plans are the best fit on an individual basis.

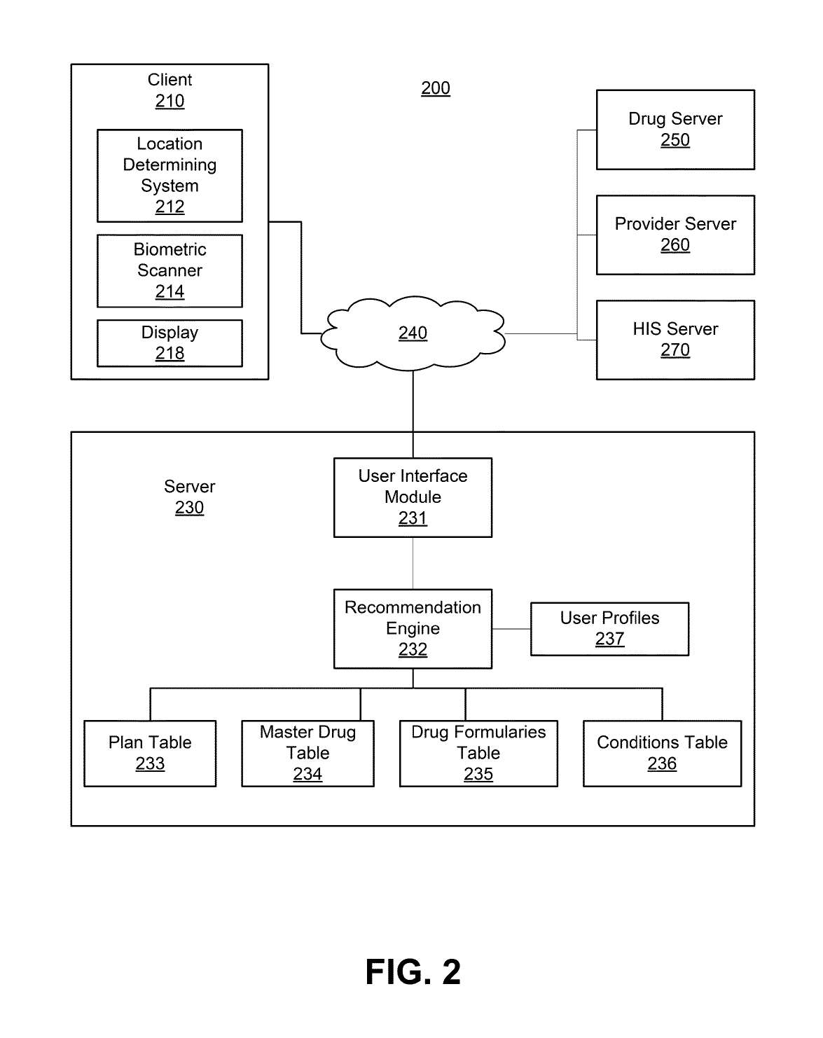

FIG. 2 illustrates a block diagram of a health insurance plan matching system 200, in accordance with an embodiment of the present invention. System 200 includes a client 210, which may be a computing system environment 100, such as that depicted in FIG. 1. System 200 is intended to support numerous clients 210, but for simplicity, only a single client 210 is shown in FIG. 2. Client 210 includes a display 218 for presenting a user interface to a user.

In one embodiment, the client 210 may include a location determining system 212 for determining the position of client 210. The location determining system 212 may perform the location determination in conjunction with one or more transceivers, including but not limited to cellular transceivers, GPS transceivers, and IEEE 802.11 (Wi-Fi) transceivers. In that regard, the location of client 210 may be determined through cellular triangulation, GPS geolocation, a Wi-Fi-based positioning system (WPS), or the like.

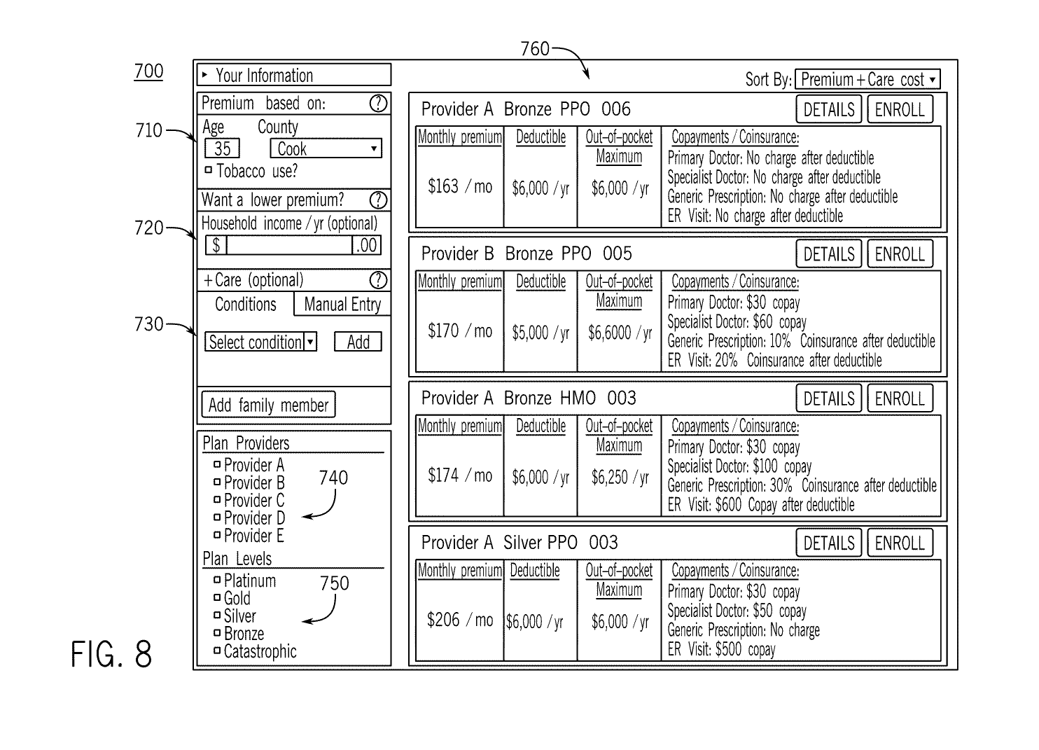

System 200 also includes a server 230, which may be a computing system environment 100, such as that depicted in FIG. 1. Server 230 is coupled to a network 240, through which it may establish communication with client 210, and operates, at least in part, to generate and provide a listing of available health insurance plans and associated costs to client 210. Server 230 includes a user interface module 231 for generating and transmitting a graphical user interface (GUI) to client 210. FIGS. 7-17 illustrate example GUIs that user interface module 231 may transmit for display on display 218 of client 210.

Server 230 also includes a recommendation engine 232, which is adapted to generate a listing of available health insurance plans and associated costs. To that end, server 230 also includes a number of tables, including but not limited to a plan table 233, a master drug table 234, a drug formularies table 235 and a conditions table 236, which recommendation engine 232 may access in order to generate the listing of available health insurance plans and associated costs.

FIG. 7 illustrates an example screen of a GUI 700 that user interface module 231 may provide to client 210. Health insurance companies often set premiums for their plans using price curves that vary based on age, location and tobacco use, among other factors. Accordingly, the GUI may include a premium requirements portion 710 that solicits such information that is required to determine base health insurance premiums for a user from client 210. The GUI may also include an income portion 720 that solicits the user's household income and a health condition portion 730 that solicits information concerning a health condition of the user. The GUI may also include a provider filter 740 for filtering displayed health insurance plans based on provider and a plan level filter 750 for filtering displayed health insurance plans based on plan level.

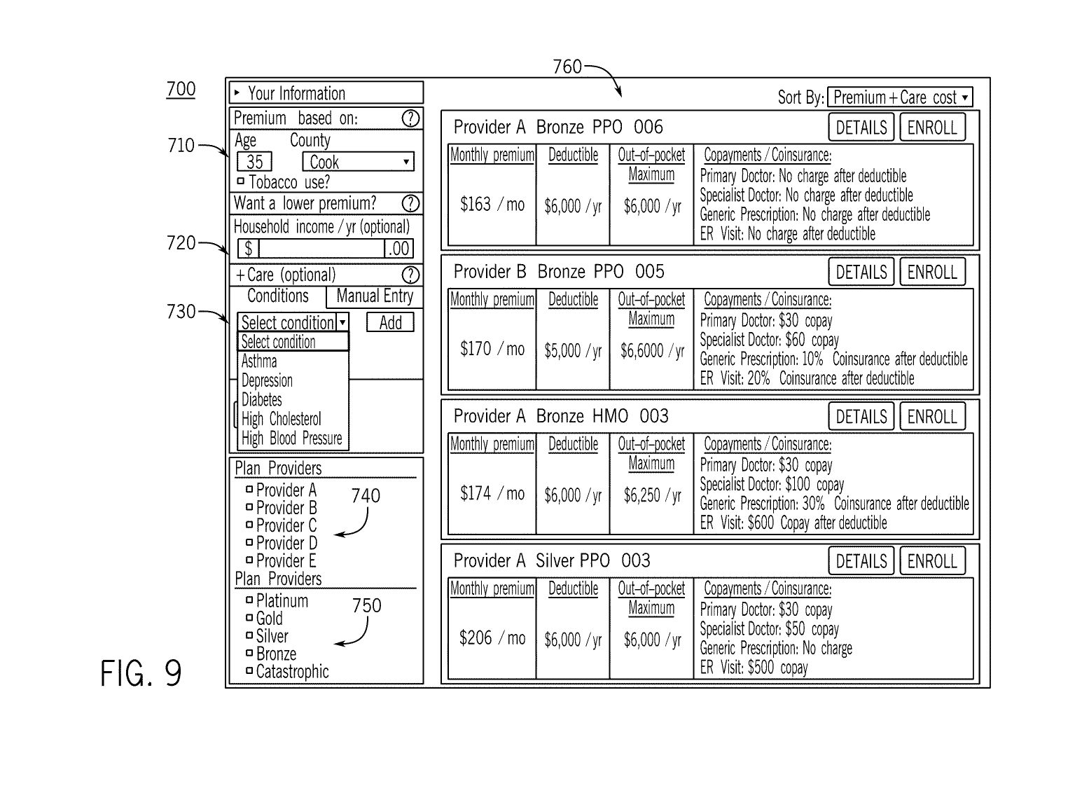

FIG. 8 illustrates another example screen of GUI in which the user has entered an age of 35 and a location of Cook County, Illinois. Client 210 transmits that information to server 230, where it is received by user interface module 231. User interface module 231 in turn passes the age and location information along to recommendation engine 232, which generates a list of available plans and their associated base premiums based on the age and location information provided. As noted above, server 230 may include a plan table 233 that includes various types of information concerning available health insurance plans. Recommendation engine 232 may consult plan table 233 in order to determine available plans and their base premiums for the user. In addition to or instead of consulting plan table 233, recommendation engine 232 may consult one or more remote provider servers 260, e.g. that are maintained by health insurance providers, that maintain up-to-date listings of health insurance plans.

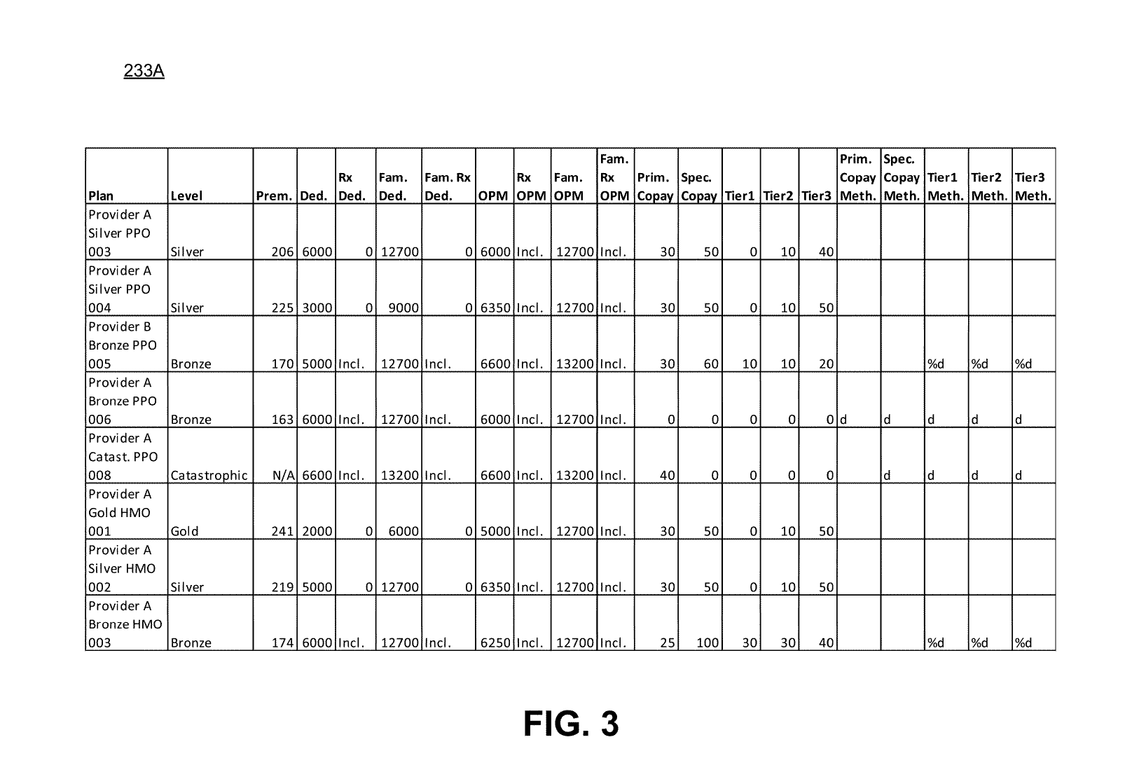

FIG. 3 illustrates an example plan table 233A, in accordance with an embodiment of the present invention. Although specific fields are disclosed in plan table 233A of FIG. 3, such fields are examples. That is, embodiments are well suited to including more or less fields than that depicted in FIG. 3. The particular plan table 233A shown in FIG. 3 is an example plan table for 35 year-old non-smokers in Cook County, Illinois. It should be appreciated that some of the values in plan table 233A—and the premium in particular—may vary depending on the age and location entered and whether the user is a smoker. It should also be appreciated that plan table 233A, or a similar set of data, may be stored on a remote provider server 260.

In the illustrated embodiment, plan table 233A includes a Plan field that identifies the provider and provides a description for each plan. Plan table 233A also includes a Level field that indicates the level of a given plan. For instance, in current US health insurance marketplaces, there are five levels of Marketplace insurance plans: Bronze, Silver, Gold, Platinum, and Catastrophic. Plan table 233A also includes fields for premium (Prem.); individual deductible (Ded.); individual prescription deductible (Rx Ded.); family deductible (Fam. Ded.); family prescription deductible (Fam. Rx Ded.); individual out-of-pocket maximum (OPM); individual prescription out-of-pocket maximum (Rx OPM); family out-of-pocket maximum (Fam. OPM); family prescription out-of-pocket maximum (Fam Rx. OPM); primary physician copay (Prim. Copay); specialist physician copay (Spec. Copay); and tier 1, 2 and 3 prescription copay (Tier 1, Tier2 and Tier3). Plan table 233A also includes a number of methodology fields (Prim. Copay Meth., Spec. Copay Meth., Tier1 Meth., Tier2 Meth. and Tier3 Meth.) that indicate when and how copays arise under a given plan. For instance, some plans may require an insured to satisfy a deductible before a prescription or doctor visit copay applies. In plan table 233A, that type of methodology is denoted by a “d” (see, for example, the Provider A Bronze PPO 006 plan). Other plans may charge a copay right away, i.e. without a deductible requirement. Such plans are denoted in plan table 233A by a blank methodology field (see, for example, the Provider A Silver PPO 003 plan). Still other plans, noted by a “%d,” may have a coinsurance requirement where a patient is responsible a certain percentage of charges after satisfying a deductible (see, for example, the prescription copay methodologies for the Provider B Bronze PPO 005 plan). For plans that utilize such a coinsurance methodology, the number provided for the corresponding copay represents the percentage of costs for which the patient is responsible after satisfying the deductible. For example, under the Provider B Bronze PPO 005 plan, the patient would be responsible for 10% of the cost of tier 1 and tier 2 prescriptions and 20% of the cost of tier 3 prescriptions after satisfying a $5,000 deductible.

With that context, plan table 233A indicates that the Provider A Bronze PPO 006 plan has the lowest base premium for a 35 year-old non-smoker in Cook County, Illinois, followed by the Provider B Bronze PPO 005 plan, followed by the Provider A Bronze HMO 003 plan, etc. Accordingly, upon receiving the premium requirement information, recommendation engine 232 would consult plan table 233A and generate a listing of available plans and their associated costs. Preferably, and as shown in FIG. 8, the list 760 generated by recommendation engine 232 and displayed on display 218 of client 210 is sorted in order of lowest cost.

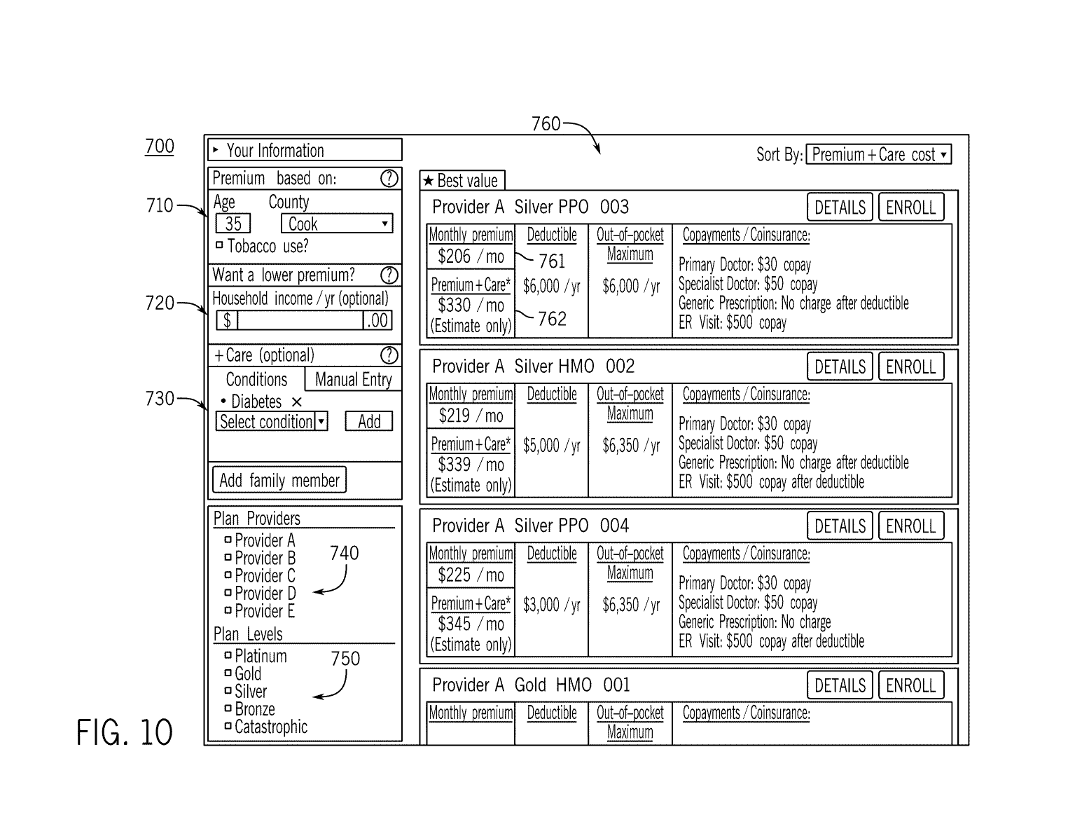

However, as noted above, the plan with the lowest premium may not necessarily provide the greatest overall value to each insured. For example, a plan with a higher monthly premium but lower deductibles, copays and out-of-pocket maximums may ultimately provide the best value for an insured who suffers from an existing condition that requires regular mediation and doctor visits. Accordingly, GUI 700 includes a health condition portion 730 that solicits health condition information about the user. The illustrated embodiment provides two mechanisms for entering health condition information. The first, shown in FIGS. 8-10, involves the identification of a specific health condition. For example, as shown in FIG. 9, health conditions from which the user may choose include asthma, depression, diabetes, high cholesterol and high blood pressure, which happen to be five of the most common chronic health conditions. It should be appreciated that those health conditions are merely exemplary and that other conditions may be used. In particular, non-chronic health conditions may also be used. For example, a user may be able to indicate that she is pregnant, has a “one-off” condition requiring surgery (e.g. knee replacement), etc.

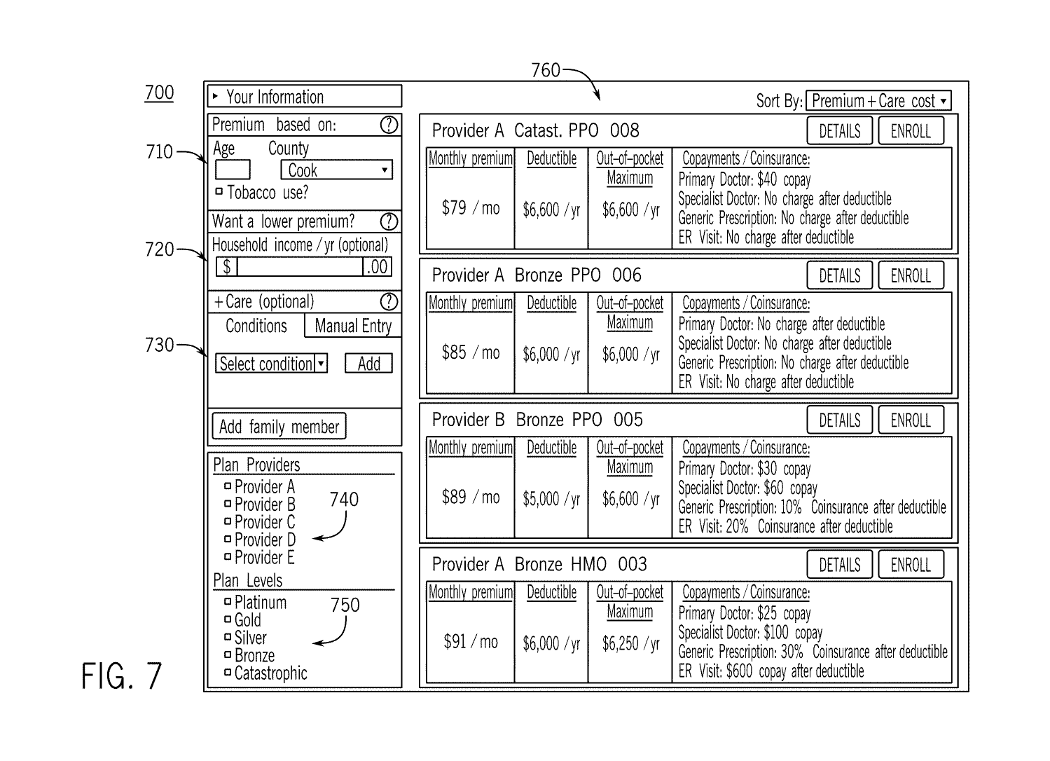

Once a user indicates a health condition, recommendation engine 232 looks up the indicated condition in conditions table 236. In addition to or instead of consulting conditions table 236, recommendation engine 232 may consult one or more remote hospital information system (HIS) servers 270 that provide minimum annual care requirements for health conditions, costs of treatment, etc. FIG. 6 illustrates an example conditions table 236A, in accordance with an embodiment of the present invention. Although specific fields are disclosed in conditions table 236A, such fields are examples. That is, embodiments are well suited to including more or less fields than those depicted in FIG. 6. It should be appreciated that conditions table 236A, or a similar set of data, may be stored on a remote HIS server 270. In the illustrated embodiment, conditions table 236A includes a Condition field that identifies a particular health condition, a number of prescription fields (Rx 1, Rx 2 and Rx 3) that identify prescription drugs that are frequently prescribed for the associated condition, a Visits to Primary Doctor/Year field, and a Visits to Specialists/Year field. The prescription fields may also include an adjustment factor that identifies the likelihood that a given prescription drug is prescribed for the associated condition.

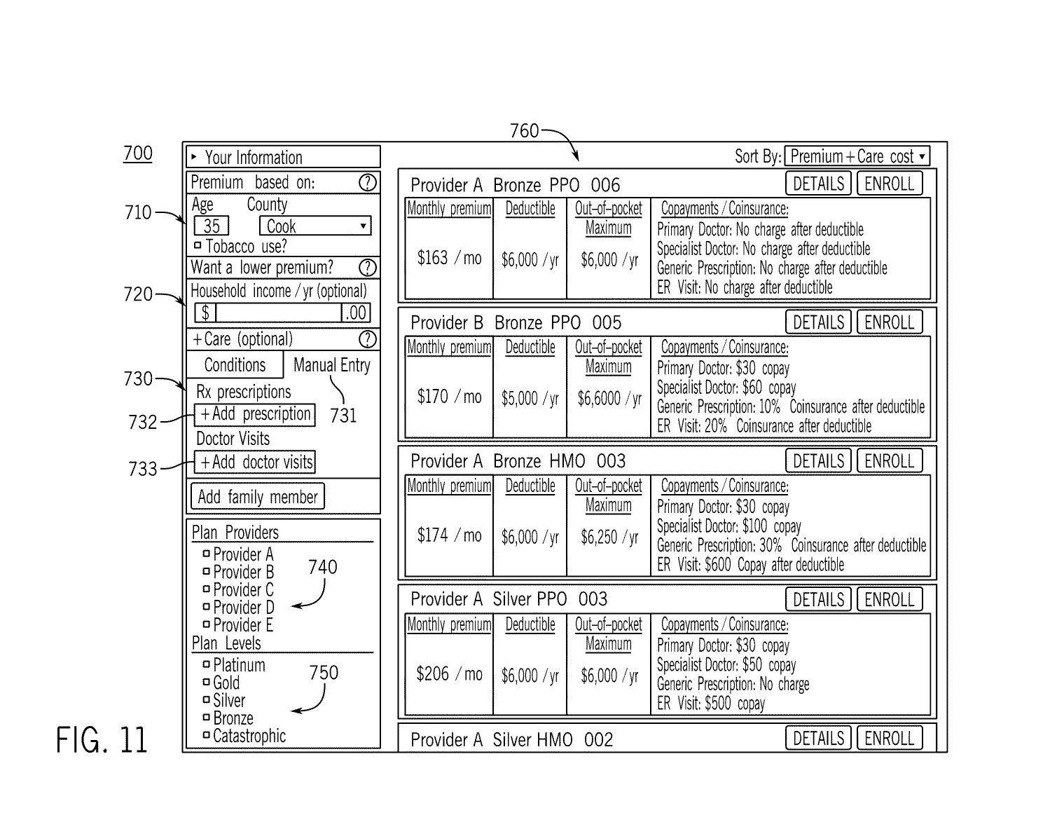

By way of example, in the illustrated embodiment of FIG. 10, the user has selected diabetes as a health condition. Recommendation engine 232 would then consult conditions table 236A, which indicates that Lantus is prescribed to 60% of diabetics, Levemir is prescribed to 40% of diabetics, diabetic lancets are prescribed to 100% of diabetics, and that diabetics require on average four annual visits to a primary care physician at a cost of $220 per visit. Based on this information, as well as information provided in the master drug table 234 and drug formularies table 235, recommendation engine 232 determines a total estimated cost of care under the benefits of each plan identified in plan table 233. In one embodiment, that amount is determined according to the following equation:

Cost=Σ(adjusted drug costs)+Σ(primary doctor costs)+Σ(specialist costs)

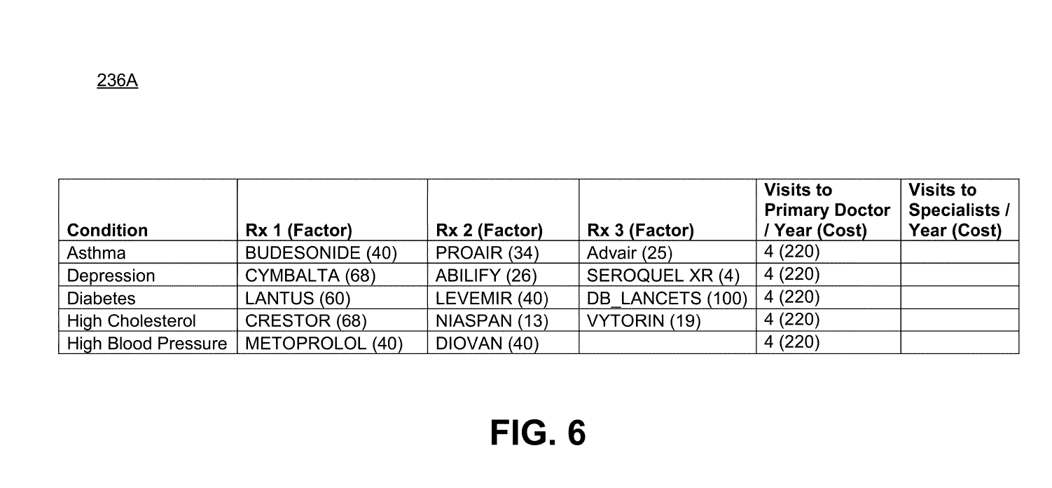

By way of example, under the Provider A Silver PPO 003 plan, primary doctor visits, specialist visits and prescriptions are not subject to a deductible. Further, the plan covers 100% of the cost of tier 1 prescriptions and has copays of $10 and $40 for tier 2 and tier 3 prescriptions and $30 and $50 for primary doctor and specialist visits. Thus, under the Provider A Silver PPO 003 plan, the cost of the four estimated primary doctor visits would be $120. To determine the total adjusted drug costs, it must first be determined under what tiers Lantus, Levemir and lancets are classified by Provider A. That information may be obtained from drug formularies table 235. In addition to or instead of consulting drug formularies table 235, recommendation engine 232 may consult one or more provider servers 260 that specify which drugs fall under which tier for certain plans. FIG. 5 illustrates an example drug formularies table 235A, in accordance with an embodiment of the present invention. Although specific fields are disclosed in drug formularies table 235A, such fields are examples. That is, embodiments are well suited to including more or less fields than those depicted in FIG. 5. It should be appreciated that drug formularies table 235A, or a similar set of data, may be stored on a remote provider server 260. In the illustrated embodiment, drug formularies table 235A includes a Brand Name field indicating the brand name of a given drug; a Generic Name field indicating the generic equivalent, if any, of a given drug; a Provider field indicating the applicable provider; and a Tier field indicating the tier level of the given drug for that provider. Under the current example of drug formularies table 235A, Provider A considers Lantus and Levemir to be tier 3 prescriptions and lancets to be a tier 2 prescription. Assuming the patient requires four 90-day supplies of each of the foregoing prescriptions, the total adjusted drug costs under the Provider A Silver PPO 003 plan would be computed as follows:

$$\begin{matrix}Σ ( adj ' d drug costs ) = ( Lantus cost ) \times 0.6 + ( Levemir cost ) \times 0.4 + ( lancet cost ) \times 1.0 \\ = ( \$40 \times 4 ) \times 0.6 + ( \$40 \times 4 ) \times 0.4 + ( \$10 \times 4 ) \times 1.0 \\ = \$210\end{matrix}$$

Thus, the total estimated healthcare cost for a diabetic under the Provider A Silver PPO 003 plan would be:

Cost=$210+$120+$0=$330

Accordingly, as shown in FIG. 10, recommendation engine 232 has provided an updated listing 760 of available plans and associated costs for a 35 year-old, diabetic non-smoker, where the associated cost for each plan includes a base premium component 761 and a healthcare cost component 762. As noted above, the healthcare cost component 762 under the Provider A Silver PPO 003 plan is shown to be $330.

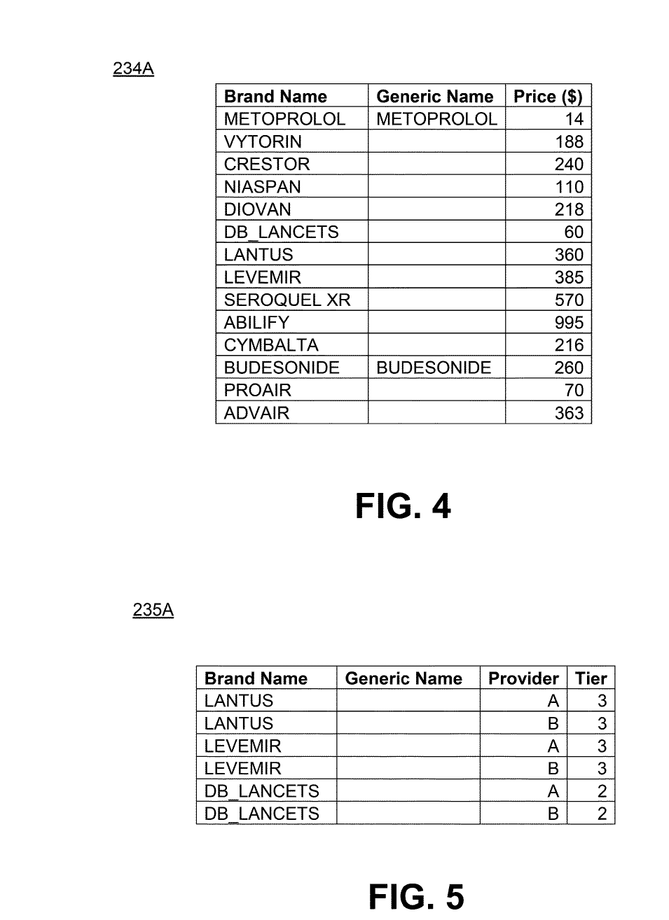

As previously noted, server 230 includes a master drug table 234, which includes retail costs of a plurality of prescriptions. Such costs may be broken down by location, such as zip code. FIG. 4 illustrates an example of one such master drug table 234A, in accordance with an embodiment of the present invention. In the above example, it was not necessary for recommendation engine 232 to consult master drug table 234 to determine the total drug costs under the Provider A Silver PPO 003 plan, because prescriptions under that plan are strictly copay. However, in plans where the insured must first satisfy a deductible, or where the insured must pay a coinsurance, the costs listed in master drug table 234A are relevant and are taken into account when calculating the total drug cost. In addition to or instead of consulting master drug table 234, recommendation engine 232 may consult one or more drug servers 250 that specify retail costs for prescriptions. To that end, drug servers may store a master drug table 234A, or a similar set of data.

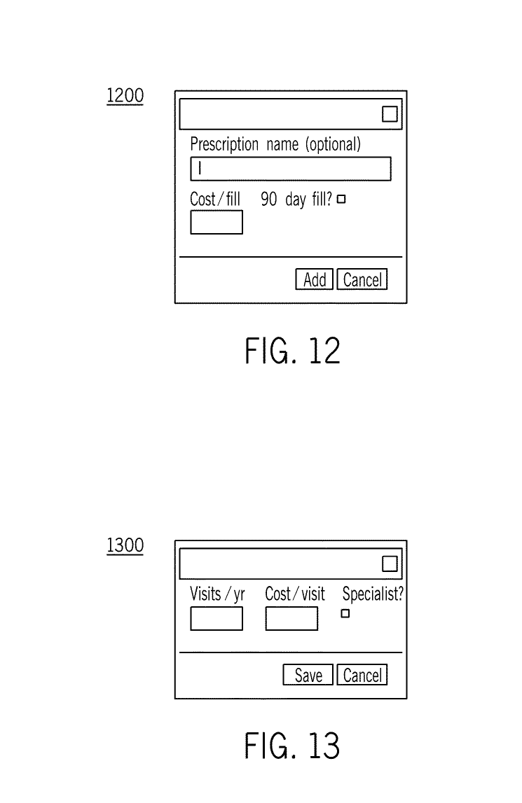

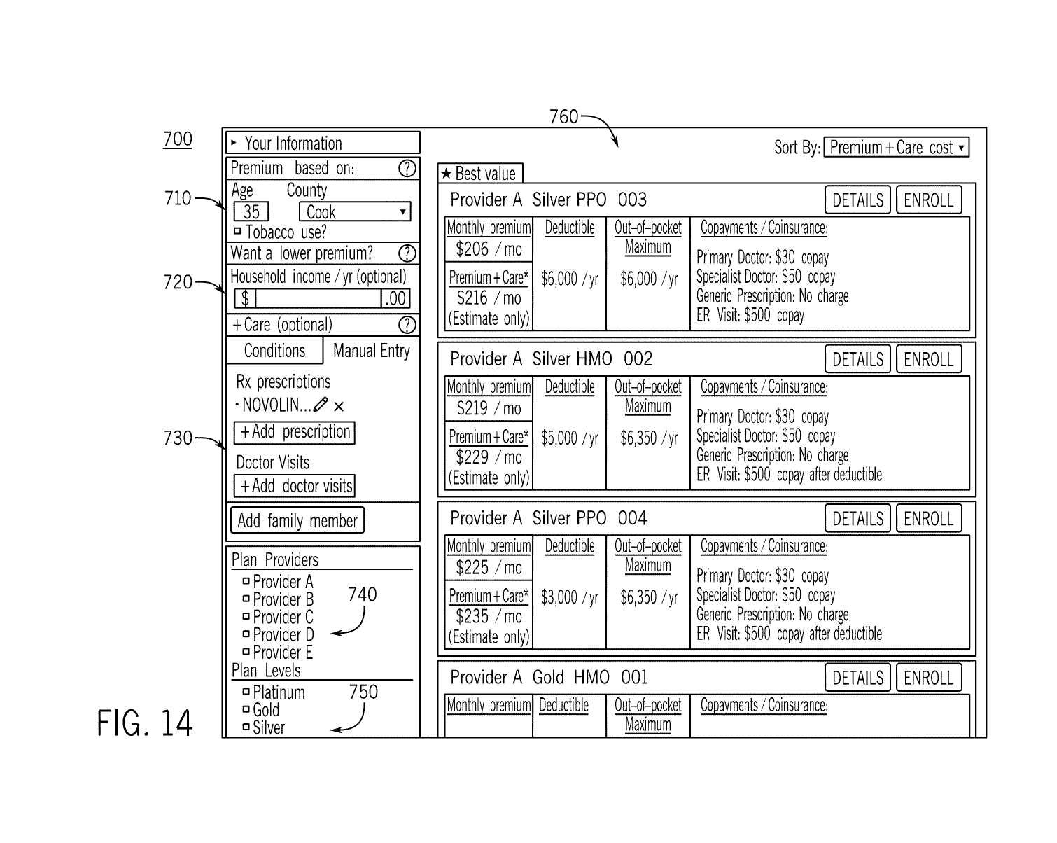

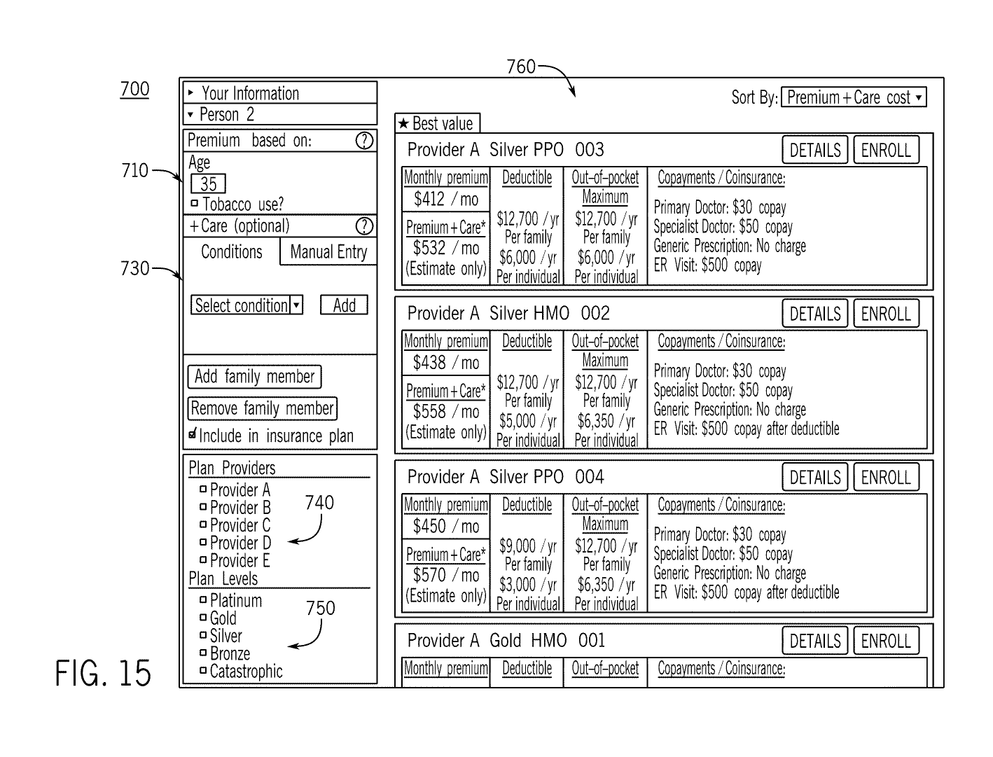

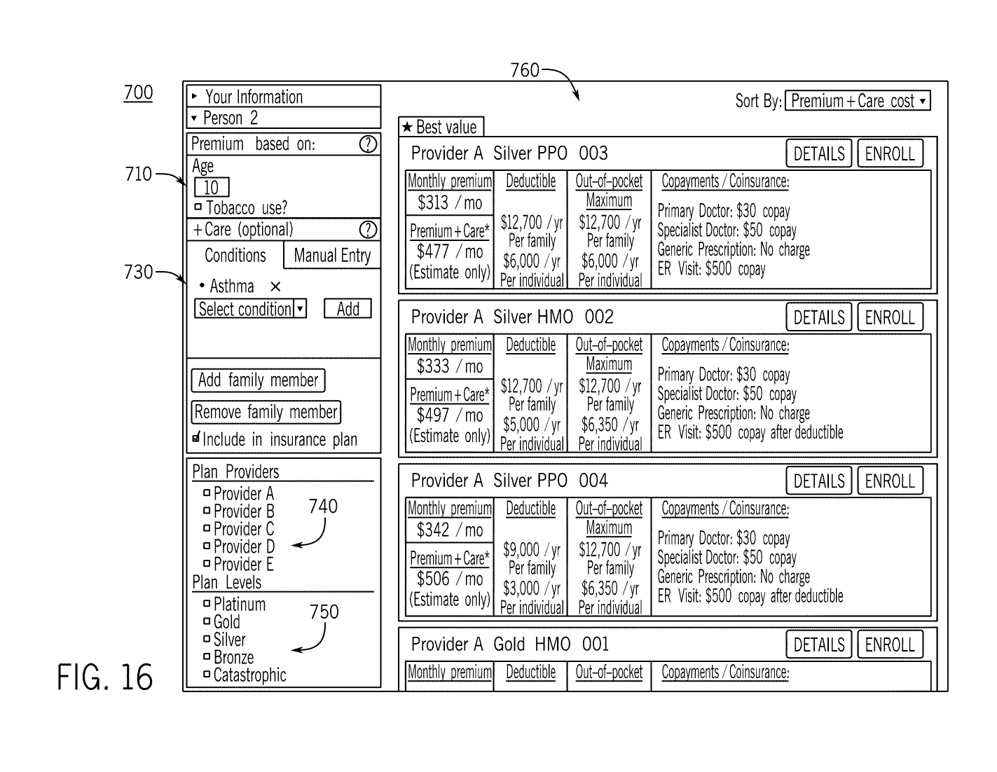

A second mechanism for entering health condition information involves the manual entry of prescription drugs a patient is taking and the associated cost, primary doctor visits per year and the associated cost, and/or specialist visits per year and the associated cost. An example of such a mechanism is depicted in FIGS. 11-14. As shown in FIG. 11, when the user of client 210 selects the Manual Entry tab 731, the user is presented with the options of adding a prescription 732 and adding doctor visits 733. When the user selects “Add prescription” 732, the user is presented with a GUI such as the one depicted in FIG. 12. As shown, GUI 1200 may request a prescription name, a cost to fill, and an indication of whether the prescription is a 90-day fill. Once the user has added a prescription, the user can select “Add prescription” 732 again to add more prescriptions. Similarly, when the user selects “Add doctor visits” 733, the user is presented with a GUI such as the one depicted in FIG. 13. As shown, GUI 1300 may request a number of doctor visits per year, a cost per visit, and an indication of whether the doctor is a specialist. Once the user has added doctor visits, the user can select “Add doctor visits” 733 again to add more doctor visits (e.g. to a specialist versus a primary care physician). As the user adds prescriptions and/or doctor visits, recommendation engine 232 may continue to consult plan table 233, master drug table 234 and drug formularies table 235 and to update listing 760 in accordance with the added information concerning the user's health condition, as shown in FIG. 14. In one embodiment, when the user has manually entered specific health condition information, it is not necessary to consult the conditions table 236, because the user's entry of specific information obviates the need to estimate “typical” healthcare costs.

In various embodiments, a user may also be able to provide an identification of the user's current and/or desired primary care and/or specialist doctor(s). With that information, recommendation engine 232 may be able to consult plan table 233 and/or provider server 260 to determine for what plans, if any those doctors are “in network.” In one embodiment, the recommendation engine 232 will generate a listing of plans and associated costs that includes only those plans for which the identified doctors are in network.

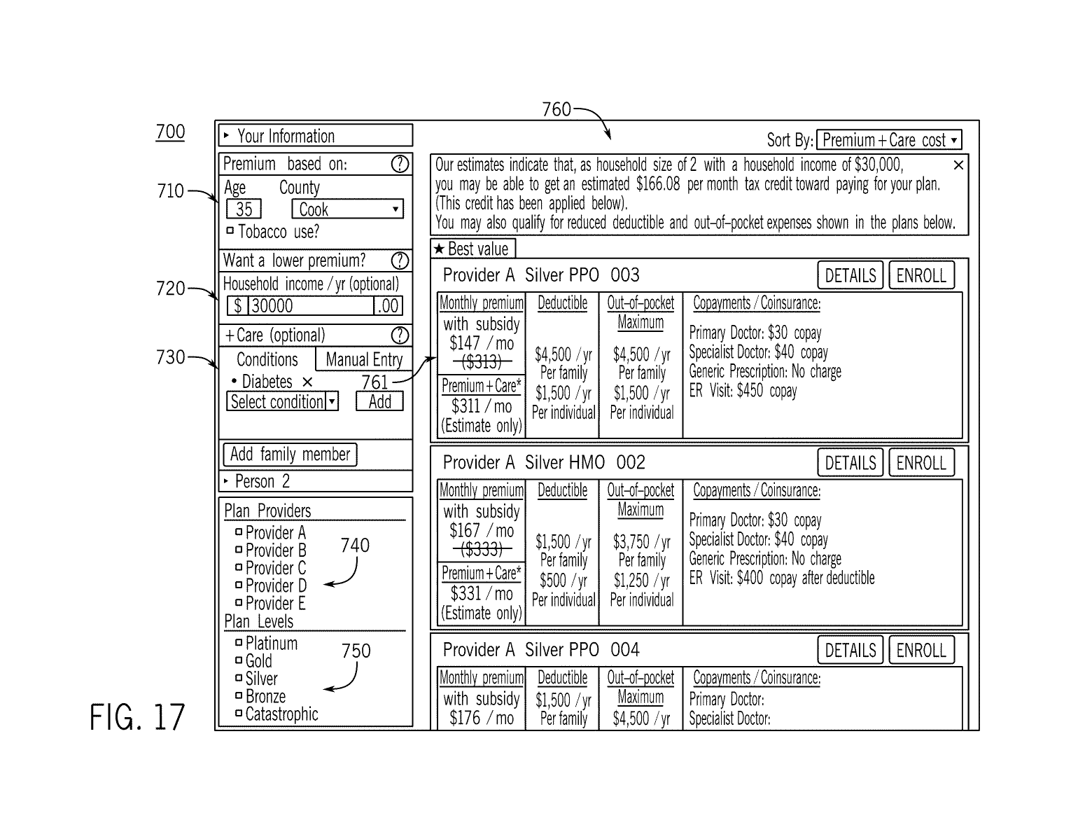

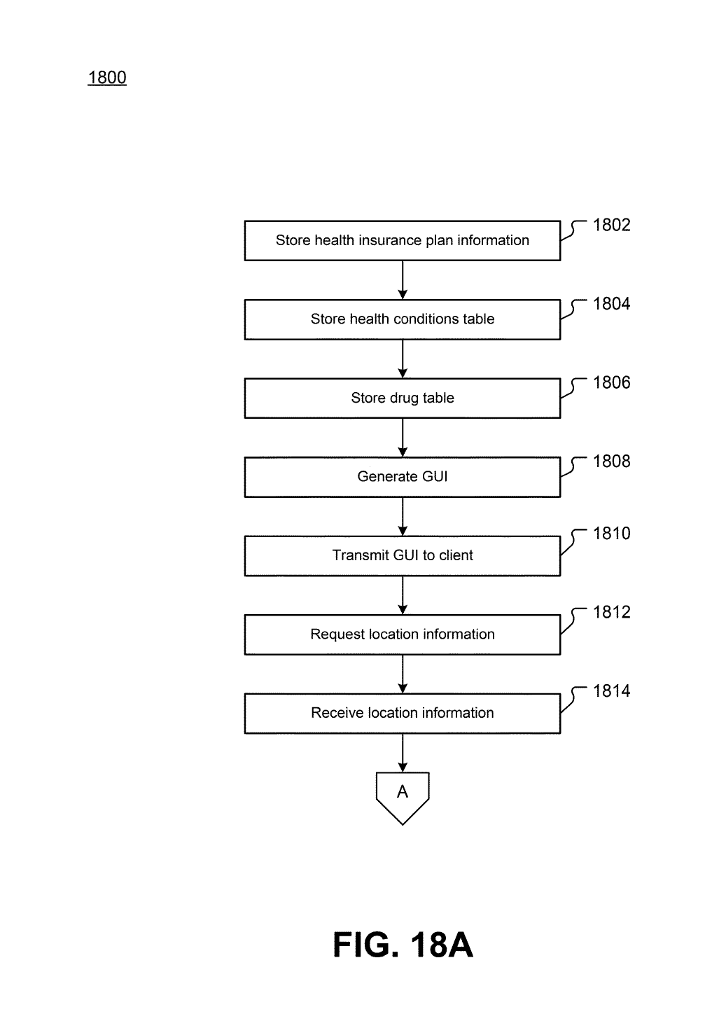

In various embodiments, server 230 is able to generate a listing of available health insurance plans and associated costs for cases involving multiple insureds (e.g. a family). As shown in FIG. 15, GUI 700 provides an option to add a family member 770. When a user selects “Add family member” 770, the previously entered information for the first insured is saved, and GUI 700 presents a fresh premium requirements portion 710 and health condition portion 730 for a second insured, i.e. “Person 2.” As shown in FIGS. 15 and 16, recommendation engine 232 may continue to update the listing 760 of available health insurance plans and associated costs, including monthly premium and healthcare costs, as information concerning additional family members is entered.

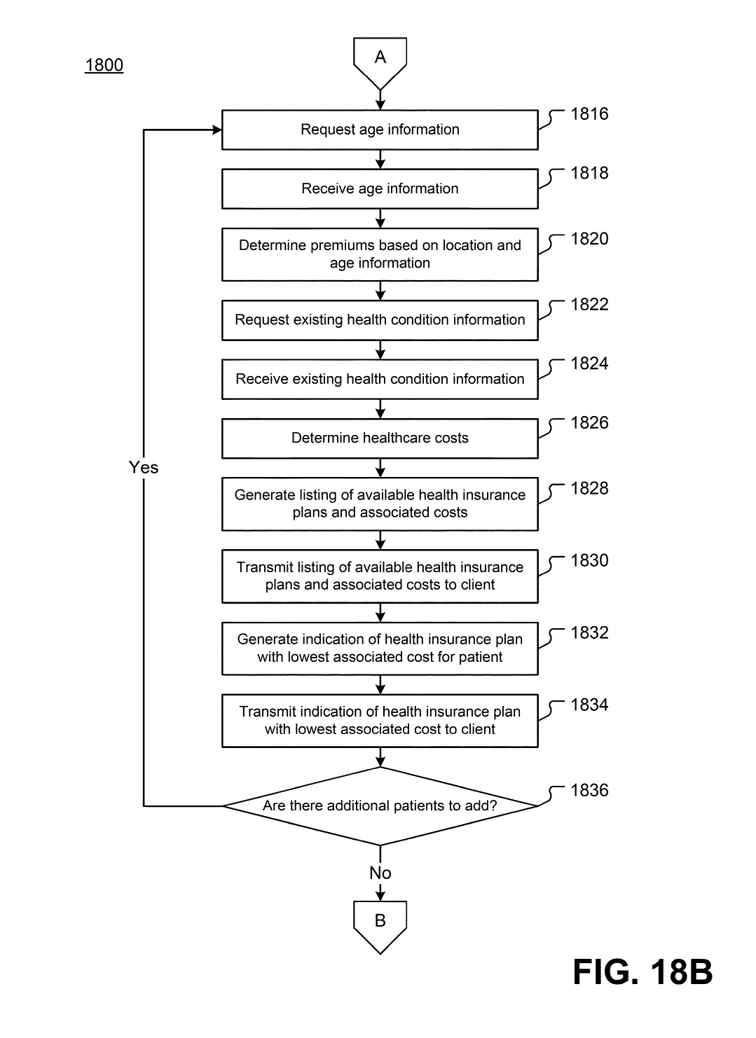

Additionally, in some embodiments, recommendation engine 232 may also account for potential tax credits and cost sharing based on the insured's household income when generating the listing 760 of available health insurance plans and associated costs. For example, in FIG. 17, the user has entered a household income of $30,000 into income portion 720 of GUI 700. In response, recommendation engine 232 has noted, via user interface module 231, that the user may be eligible for a $168 per month tax and has updated listing 760 accordingly, including updating base premium component 761 to reflect the credit. Recommendation engine 232 has additionally noted, via user interface module 231, that the user may qualify for reduced deductible and out-of-pocket expenses (also known as cost-sharing) and has updated listing 760 accordingly, including updating the deductibles and out-of-pocket maximums for the listed plans. (Compare the deductibles and out-of-pocket maximums of FIG. 17 with those of FIG. 10.)

Still further, in some embodiments, server 230 may allow client 210 to create a user profile 237 to save the information that client 210 has supplied, so that it can be recalled at a later time. Each of user profiles 237 may be accessed through a user name and password combination. Alternatively, some or all of user profiles 237 may be accessed based on biometric recognition. For example, client 210 may include a biometric scanner 214, such as a fingerprint scanner, that reads and transmits a user's fingerprint at the time a user profile 237 is created and/or is subsequently accessed, to verify the user's identity. Such biometic recognition may be instead of or in addition to user name and password authentication.

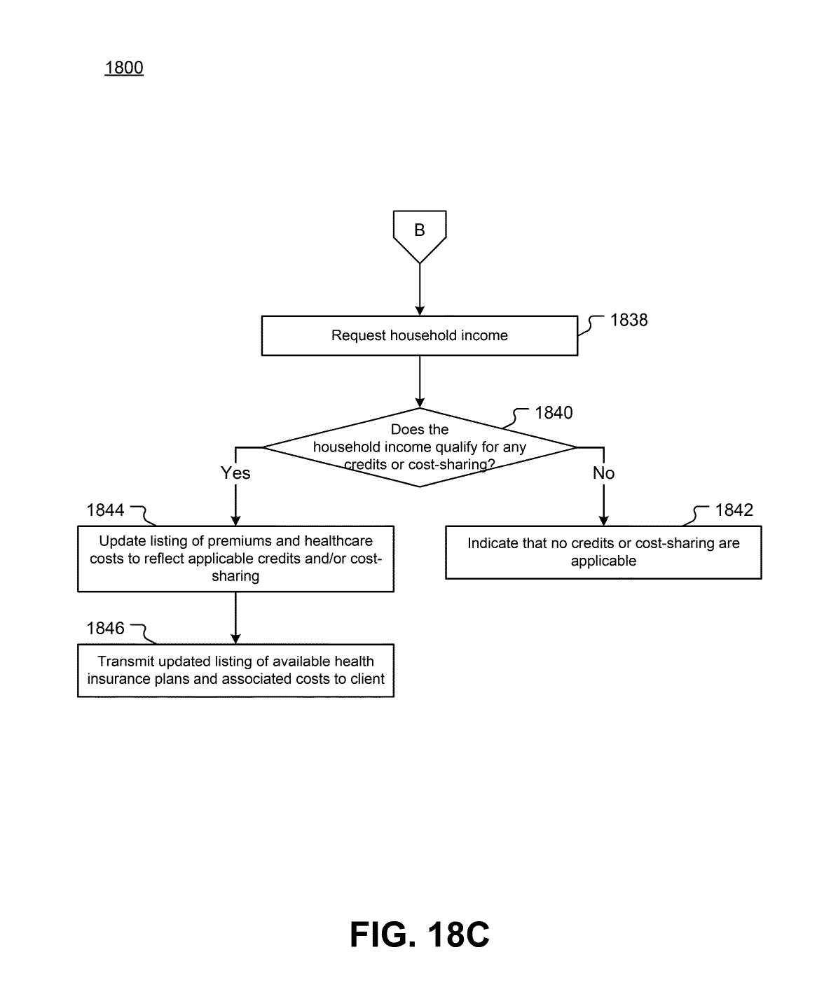

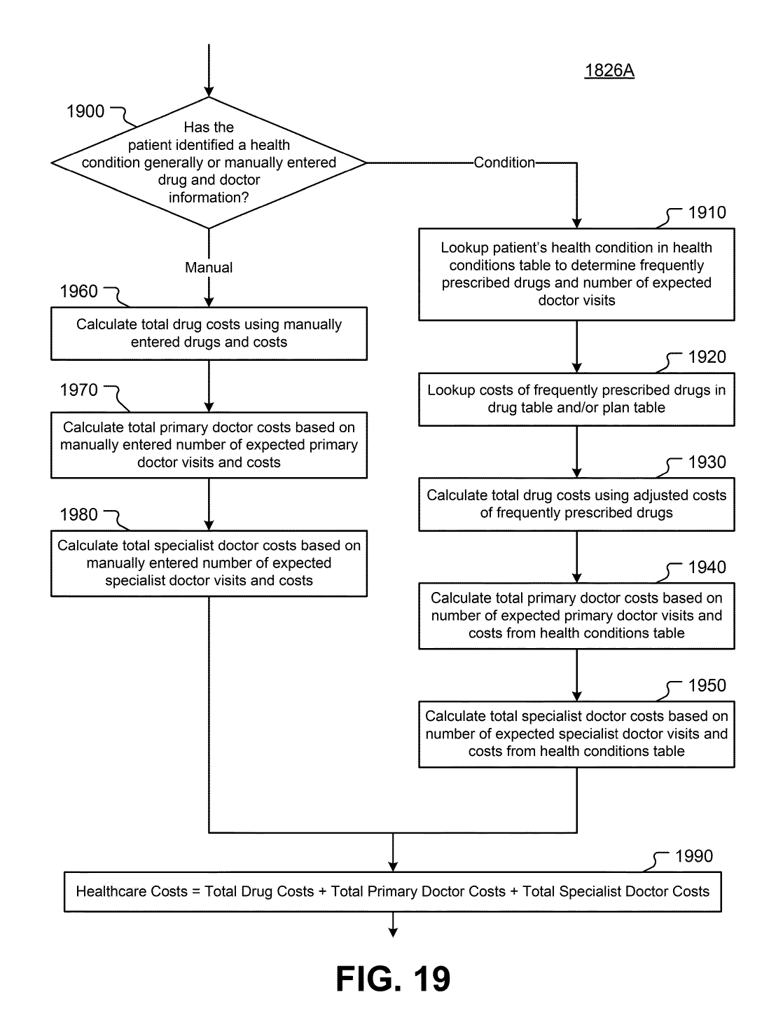

The following discussion sets forth in detail the operation of present technology for health insurance plan matching. With reference to FIGS. 18 and 19, flowcharts 1800 and 1826A each illustrate example steps used by various embodiments of the present technology for a health insurance plan matching system 200. Flowcharts 1800 and 1826A include processes that, in various embodiments, are carried out by a processor under the control of computer-readable and computer-executable instructions. The computer-readable and computer-executable instructions may reside, for example, in data storage features such as storage media 138, 140 and 142 of FIG. 1. Although specific operations are disclosed in flowcharts 1800 and 1826A, such operations are examples. That is, embodiments are well suited to performing various other operations or variations of the operations recited in flowcharts 1800 and 1826A. It is appreciated that the operations in flowcharts 1800 and 1826A may be performed in an order different than presented, and that not all of the operations in flowcharts 1800 and 1826A may be performed. Where helpful for the purposes of illustration and not for limitation, FIGS. 18 and 19 will be described with reference to FIGS. 1-17, which illustrate hypothetical situations in which embodiments may be implemented.

FIGS. 18A, 18B and 18C illustrate first, second and third portions, respectively, of a flowchart 1800 for a method for generating a listing of available health insurance plans and associated costs, in accordance with various embodiments of the present invention. For ease of reference, FIGS. 18A, 18B and 18C shall collectively be referred to herein as simply “FIG. 18.” Flowchart 1800 begins at block 1802, where health insurance plan information is stored. Such information may be stored, for example, in a plan table 234, of which plan table 234A of FIG. 3 is an example. At block 1804, a health conditions table 236 is stored, of which conditions table 236A is one example. At block 1806, a drug table is stored. While FIG. 2 depicts two drug tables, namely master drug table 234 and drug formularies table 235, it should be appreciated that the information stored in those tables could be stored in a single table.

Next, a GUI is generated (block 1808), for example by a user interface module 231, and transmitted to a client 210 (block 1810). Once transmitted, the GUI may then request location information from the client 210 (block 1812). Location information may then be received from the client 210 (block 1814). In one embodiment, such location information may be received via manual entry on the client 210 by a user, such as by indicating an address, a zip code, a county and state, or the like. In another embodiment, such information may be determined and received via a location determining system 212 on the client 210. At block 1816, age information is requested from the client 210, namely, the age of a potential insured. At block 1818, age information is received.

Once location and age information have been received, premiums of available health insurance plans may be determined (block 1820), for example, by a recommendation engine 232, based on the received location and age information. This may be achieved, for example, by accessing a plan table 233 corresponding to the location and age or a plan table 233 corresponding to the location that provides means (e.g. an age/rate curve) for calculating the premium based on the age.

At block 1822, health condition information is requested, for example, via a user interface module 231 and a GUI 700. At block 1824, health condition information is received. It should be appreciated that such information may be received in a number of different manners. For example, in one embodiment, the health condition information may identify a specific health condition, as shown in FIGS. 9 and 10 for example. In one embodiment, the health condition information may specify a medication being taken and/or a number of doctor visits per year (e.g. necessitated by a chronic health condition), as shown in FIGS. 11-14.

At block 1826, healthcare costs are determined based on the health condition information received. It should be appreciated that this may be achieved in a number of ways. For example, FIG. 19 illustrates a flowchart 1826A for a method for determining healthcare costs, in accordance with various embodiments of the present invention. Flowchart 1826A begins at block 1900, where a determination is made as to whether the patient has identified a healthcare generally or has manually entered drug and doctor information. If the patient has manually entered drug and doctor information, then flowchart 1826 proceeds to block 1960, where total drug costs under available health insurance plans are calculated using the drugs and costs entered by the user/patient. At block 1970, total primary doctor costs are calculated based on the manually entered number of expected primary doctor visits and costs. Further, at block 1980, total specialist doctor costs are calculated based on the manually entered number of expected specialist visits and costs. Each of the calculations of steps 1960, 1970 and 1980 may be determined, in part, by consulting a plan table to determine whether and to what extent deductibles, copays and coinsurance apply for each plan. At block 1990, the total healthcare costs are determined by summing the total drug costs, the total primary doctor costs and the total specialist costs.

Referring again to decision block 1900, if the patient has identified a health condition generally (e.g. by name), then flowchart 1826A proceeds to block 1910, where the patient's health condition is looked up in a conditions table to determine frequently prescribed drugs and the number of expected doctor visits for the identified health condition. The costs of the frequently prescribed drugs under the available health insurance plans are then looked up in a drug table and/or a plan table 233 (block 1920), as discussed in greater detail above. The costs of the frequently prescribed drugs may vary from plan to plan based on variations in deductibles, copays and coinsurances and the plans' rules and methodologies applicable to same. At block 1930, the total drug costs are calculated using adjusted costs of the frequently prescribed drugs. For example, as discussed above, the cost of a given drug may be multiplied by an adjustment factor corresponding to frequency at which the drug is prescribed for the identified health condition. At block 1940, total primary doctor costs are calculated based on the number of expected primary doctor visits and costs from the health conditions table 236. Similarly, at block 1950, total specialist costs are calculated based on the number of expected specialist visits and costs from the health conditions table 236. In the calculations of both block 1940 and block 1950, both may take into account the applicable deductibles, copays, etc. of the available plans. At block 1990, the total healthcare costs are determined by summing the total drug costs, the total primary doctor costs and the total specialist costs.

Referring again to FIG. 18, once the healthcare costs have been determined, a listing of available health insurance plans and associated costs is generated (block 1828) and transmitted to client 210 (block 1830). Although block 1830 is depicted in a particular position within flowchart 1800, it should be appreciated that the step of generating a listing of available plans and associated costs may be performed at numerous other locations within the process. For example, as discussed above, an embodiment may include a GUI 700 that dynamically updates as a user enters information. At blocks 1832 and 1834, an indication of the health insurance plan with the lowest overall cost for the patient is generated and transmitted to client 210. For example, in the example of FIG. 10, the Provider A Silver PPO 003 plan is denoted as a “Best value” based on the information supplied by the patient/user.

At block 1836, a determination is made as to whether there are additional patients to add. This may be achieved by determining whether an “Add family member” feature 770 has been selected. If there are additional patients to add, then flowchart 1800 returns to block 1816, and blocks 1816 through 1834 are repeated. If not, flowchart 1800 proceeds to block 1838, where household income is requested. At block 1840, a determination is made as to whether the household income qualifies for any credits or cost-sharing. If not, then flowchart 1800 proceeds to block 1842, where an indication that no credits or cost-sharing are applicable is made. If the household income does qualify for a credit and/or cost-sharing, then flowchart proceeds to block 1844, where the listing of premiums and healthcare costs for available health insurance plans is updated to reflect the applicable credits and/or cost-sharing. The updated listing is then transmitted to client 210 (block 1846).

Thus, various embodiments of the present invention provide for health insurance plan matching that takes into account a patient's health condition information so as identified those plans that, while they may not have the lowest base premium, may nevertheless be the lowest cost to the patient once the plan's benefits are applied to the healthcare received. Such embodiments take what is normally a complicated decision and make it simple by showing a potential insured “true costs” of available insurance plans once the plans' benefits have been applied to consumed healthcare services, prescriptions, etc.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An apparatus for generating a listing of available health insurance plans and associated costs for a client that is communicatively coupled with the apparatus via a network, the apparatus comprising:
a user interface module for generating and transmitting a graphical user interface (GUI) to a client, the user interface module requesting and receiving via the GUI information concerning an existing health condition of a patient;
a recommendation engine communicatively coupled with the user interface module, wherein the recommendation engine is adapted to receive the information concerning the existing health condition of the patient from the user interface module; and
one or more databases communicatively coupled with the recommendation engine, the one or more databases storing information concerning a plurality of health insurance plans, the information including at least an identifier for each plan and a description of benefits for each plan,
wherein the recommendation engine is further adapted to analyze the information concerning the health insurance plans in view of the received information concerning the existing health condition of the patient and generate and provide to the user interface module the listing of available health insurance plans and associated costs, wherein the associated costs for a given health insurance plan in the listing includes at least a health insurance premium component and a healthcare cost component, the healthcare cost component being based on the information concerning the existing health condition of the patient, and
wherein the user interface module is adapted to transmit the listing of available health insurance plans and associated costs to the client to be displayed via the GUI.

2. The apparatus of claim 1, wherein the information concerning the existing health condition of the patient comprises an identification of the existing health condition.

3. The apparatus of claim 2, wherein the one or more databases store a health conditions table and a drug table, wherein the drug table includes a list of frequently prescribed drugs, costs of the frequently prescribed drugs, and rate tiers in which the frequently prescribed drugs are classified by the providers of the health insurance plans, wherein the health conditions table correlates each of a plurality of potential existing health conditions with one or more frequently prescribed drugs, a number of expected doctor visits, and a cost per doctor visit, and wherein the recommendation engine determines the healthcare cost component of the associated costs for a given health insurance plan by determining the costs of the frequently prescribed drugs and expected doctor visits associated with the identified existing healthcare condition of the patient under the benefits of the given health insurance plan.

4. The apparatus of claim 3, wherein the health conditions table includes an adjustment factor for each of the frequently prescribed drugs, the adjustment factor identifying the likelihood that a given frequently prescribed drug is prescribed for a correlated potential existing health condition, and wherein the recommendation engine determines the costs of the frequently prescribed drugs associated with the identified existing healthcare condition by adjusting the costs of the frequently prescribed drugs associated with the identified healthcare condition to account for the associated adjustment factors and then summing the adjusted costs of the frequently prescribed drugs associated with the identified healthcare condition.

5. The apparatus of claim 1, wherein the information concerning the existing health condition of the patient comprises a prescription drug that the patient is taking and a cost of the prescription drug.

6. The apparatus of claim 5, wherein the one or more databases store a drug table that includes a list of frequently prescribed drugs, costs of the frequently prescribed drugs, and rate tiers in which the frequently prescribed drugs are classified by the providers of the health insurance plans, and wherein the recommendation engine determines at least a portion of the healthcare cost component of the associated costs for a given health insurance plan by determining the cost of the prescription drug that the patient is taking under the benefits of the given health insurance plan.

7. The apparatus of claim 1, wherein the information concerning the existing health condition of the patient comprises a number of doctor visits and a cost per visit.

8. The apparatus of claim 7, the recommendation engine determines at least a portion of the healthcare cost component of the associated costs for a given health insurance plan by determining the cost of the doctor visits under the benefits of the given health insurance plan.

9. The apparatus of claim 7, wherein the information concerning the existing health condition of the patient further comprises an indication of whether the doctor visited is a specialist.

10. The apparatus of claim 1, wherein the recommendation engine is further adapted to generate and provide to the user interface module an indication of the health insurance plan that is determined to have the lowest associated cost to the patient based on the information concerning the existing health condition of the patient.

11. A method for generating a listing of available health insurance plans and associated costs, the method comprising:
storing in one or more databases information concerning a plurality of health insurance plans, the information including at least an identifier for each plan and a description of benefits for each plan;
generating a graphical user interface (GUI);
transmitting the GUI to a client;
requesting via the GUI information concerning an existing health condition of a patient;
receiving the information concerning the existing health condition from the client via the GUI;
determining healthcare costs for the patient under the health insurance plans based on the information concerning the existing health condition of the patient;
generating the listing of available health insurance plans and associated costs, wherein the associated costs for a given health insurance plan in the listing includes at least a health insurance premium component and the corresponding healthcare cost for the patient under the given health insurance plan; and
transmitting the listing of available health insurance plans and associated costs to the client to be displayed via the GUI.

12. The method of claim 11, wherein the information concerning the existing health condition of the patient comprises an identification of the existing health condition.

13. The method of claim 12, further comprising:
storing in the one or more databases a health conditions table and a drug table, wherein the drug table includes a list of frequently prescribed drugs, costs of the frequently prescribed drugs, and rate tiers in which the frequently prescribed drugs are classified by the providers of the health insurance plans, and wherein the health conditions table correlates each of a plurality of potential existing health conditions with one or more frequently prescribed drugs, a number of expected doctor visits, and a cost per doctor visit; and
wherein determining healthcare costs for the patient under the health insurance plans based on the information concerning the existing health condition of the patient comprises determining the costs of the frequently prescribed drugs and expected doctor visits associated with the identified existing healthcare condition of the patient under the benefits of the health insurance plans.

14. The method of claim 13, wherein the health conditions table includes an adjustment factor for each of the frequently prescribed drugs, the adjustment factor identifying the likelihood that a given frequently prescribed drug is prescribed for a correlated potential existing health condition, and wherein determining the costs of the frequently prescribed drugs associated with the identified existing healthcare condition comprises:
adjusting the costs of the frequently prescribed drugs associated with the identified healthcare condition to account for the associated adjustment factors; and
summing the adjusted costs of the frequently prescribed drugs associated with the identified healthcare condition.

15. The method of claim 11, wherein the information concerning the existing health condition of the patient comprises a prescription drug that the patient is taking and a cost of the prescription drug.

16. The method of claim 15, further comprising:
storing in the one or more databases a drug table that includes a list of frequently prescribed drugs, costs of the frequently prescribed drugs, and rate tiers in which the frequently prescribed drugs are classified by the providers of the health insurance plans; and
wherein determining healthcare costs for the patient under the health insurance plans based on the information concerning the existing health condition of the patient comprises determining the costs of the prescription drug that the patient is taking under the benefits of the health insurance plans.

17. The method of claim 11, wherein the information concerning the existing health condition of the patient comprises a number of doctor visits and a cost per visit.

18. The method of claim 17, wherein determining healthcare costs for the patient under the health insurance plans based on the information concerning the existing health condition of the patient comprises determining the cost of the doctor visits under the benefits of the given health insurance plan.

19. The method of claim 17, wherein the information concerning the existing health condition of the patient further comprises an indication of whether the doctor visited is a specialist.

20. The method of claim 11, further comprising:
generating an indication of the health insurance plan that is determined to have the lowest associated cost to the patient based on the information concerning the existing health condition of the patient; and
transmitting the indication of the health insurance plan that is determined to have the lowest associated cost to the patient to the client to be displayed via the GUI.

21. A system for generating a listing of available health insurance plans and associated costs for a client that is communicatively coupled with the apparatus via a network, the system comprising:
a network;
a client communicatively coupled with the network; and
a server communicatively coupled with the client via the network, the server comprising:
a user interface module for generating and transmitting a graphical user interface (GUI) to a client, the user interface module requesting and receiving via the GUI information concerning an existing health condition of a patient;
a recommendation engine communicatively coupled with the user interface module, wherein the recommendation engine is adapted to receive the information concerning the existing health condition of the patient from the user interface module; and
one or more databases communicatively coupled with the recommendation engine, the one or more databases storing information concerning a plurality of health insurance plans, including at least an identifier for each plan and a description of benefits for each plan,
wherein the recommendation engine is further adapted to analyze the information concerning the health insurance plans in view of the received information concerning the existing health condition of the patient and generate and provide to the user interface module the listing of available health insurance plans and associate costs, wherein the associated costs for a given health insurance plan in the listing includes at least a health insurance premium component and a healthcare cost component, the healthcare cost component being based on the information concerning the existing health condition of the patient, and
wherein the user interface module is adapted to transmit the listing of available health insurance plans and associated costs to the client to be displayed via the GUI.
